(19) United States
(12) Patent Application Publication
(10) Pub. No.: US 2008/0086687 A1
(43) Pub. Date: Apr. 10, 2008

(54) Graphical User Interface For Audio-Visual Browsing

(76) Inventors: Ryutaro Sakai, Marina Del Rey, CA (US); Hemant Jha, Los Angeles, CA (US)

Correspondence Address: FITCH EVEN TABIN & FLANNERY, 120 SOUTH LASALLE SUITE 1600, CHICAGO, IL, 60603, US

(21) Appl. No.: 11/539,547

(22) Filed: Oct. 6, 2006

(51) Int. Cl. G06F 3/00; G06F 3/048; G06F 3/16

(52) U.S. Cl. 715/716; 715/727; 715/810

(57) ABSTRACT

An improved graphical user interface (GUI) is for use with an audio player or other device having a touchscreen or similar display, according to one embodiment of the invention. The content that is available for playing is represented on the GUI by a plurality of thumbnails, such as for example jacket cover art, displayed in a matrix. The matrix includes multiple playlists stacked vertically. A highlighted cursor or other selection indicator can be moved across the touchscreen and the thumbnails by a user, thus allowing the user to listen to the music or other content associated with a selected thumbnail. As the selection indicator moves between two thumbnails, the song/content associated with the first thumbnail crossfades into the song/content associated with the next thumbnail.

### 1. FIELD OF INVENTION

This relates to a system and method for using a graphical user interface (GUI) for playing audio content.

### 2. BACKGROUND

Various software applications exist that allow users to play audio content on computers, audio players and other electronic devices. These programs in combination with certain hardware advances provide users with a number of features that provide an improved user experience. For example, audio players and most computers run media player applications that are able to play audio streams of data stored on compact discs (CDs), flash memories, hard disk drives, etc.

Generally, media player applications provide a user interface (UI) for entering commands that control the playback of the audio content. For example, a UI may provide a plurality of control icons, such as buttons, arrows, levers, etc., for playing, pausing, and fast-forwarding the content by the audio player. Many UIs allow the user to display metadata, such as track information, associated with a CD or audio stream by selecting the appropriate icon. Such track information can include playing times, track numbers, song titles, identities of artists, etc. In the past, UIs have had a large degree of standardization in their layout and functionality. However, it is desirable to provide improved UI's that are more aesthetically-pleasing and user-friendly.

### SUMMARY OF THE ILLUSTRATED EMBODIMENTS

One embodiment of the invention includes an improved graphical user interface (GUI) for use with an audio player (or other device) having a touchscreen or similar display. The content that is available for playing is represented by a plurality of thumbnails, such as for example jacket cover art, displayed in a matrix. A highlighted cursor or other selection indicator can be moved across the touchscreen and the thumbnails by a user, thus allowing the user to listen to the music or other content associated with the selected thumbnail. As the selection indicator moves between any two given thumbnails, the song or other content associated with the first thumbnail crossfades into the song/content associated with the next thumbnail thereby permitting a smooth listening experience for each content selection that is being browsed.

In one aspect, the GUI is for use with a user input device and for playing a plurality of audio streams. The GUI includes a plurality of content icons displayed in a matrix and associated with the plurality of audio streams. A selection indicator is adapted to move in response to the user input device. A first one of the audio streams is played if the selection indicator is generally aligned with a first one of the content icons. A second one of the audio streams is played if the selection indicator is generally aligned with a second one of the content icons. The first audio stream crossfades into the second audio stream in response to a movement of the selection indicator from the first content icon to the second content icon.

In another aspect, the first content icon is displayed at a first brightness and the remaining of the plurality of content icons is displayed at a second brightness that is less than the first brightness when the first audio stream is playing and the second audio stream is not playing. The second content icon is displayed at the first brightness and the remaining of the plurality of content icons is displayed at the second brightness when the second audio stream is playing and the first audio stream is not playing.

In another aspect, the first audio stream is played at a first decibel level and the second audio stream is played at a second decibel level when the first audio stream crossfades into the second audio stream. The first and second decibel levels are in proportion to the proximity of the selection indicator to a position of general alignment with the first or second content icon.

In another aspect, the GUI is for display on a touchscreen responsive to the user input device. The plurality of content icons is not displayed after a first predetermined time period has elapsed during which no user command was entered using the GUI. The plurality of content icons fades into view in response to placement of the user input device on the touchscreen.

In another aspect, the touchscreen is horizontally mounted on a base unit that encloses circuitry for use in playing the audio streams. The GUI is further for use with a portable storage device that contains data for use in generating the plurality of audio streams. The plurality of content icons is not displayed after a first predetermined time period has elapsed during which no user command was entered using the GUI. The plurality of content icons fades into view in response to placement of the portable storage device on the touchscreen.

In yet another aspect, the matrix of content icons is adapted to scroll from left to right and from right to left, and to scroll from top to bottom and from bottom to top, thereby displaying additional content icons associated with additional audio streams.

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 is a simplified schematic view of an audio player according to an embodiment of the invention;

FIG. 2 is a simplified component diagram of the audio player of FIG. 1;

FIGS. 3-5 show a graphical user interface in accordance with an embodiment of the invention;

FIGS. 6-7 show a graphical user interface with a portable storage device in accordance with another embodiment of the invention;

FIG. 8 shows another graphical user interface in accordance with yet another embodiment of the invention; and

FIG. 9 is a flow diagram showing a method of playing audio streams according to an embodiment of the invention.

### DETAILED DESCRIPTION

The following description is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

According to one embodiment of the invention, an improved GUI for use with an audio player having a touchscreen or other display is provided. The content that is available for playing is represented by a plurality of thumbnails of jacket cover art, displayed in a matrix. The matrix includes multiple playlists stacked vertically. Each horizontal row corresponds to one playlist, representing for example music album, genre, artist, user favorites, etc.

Because each audio stream (i.e., each song title) within a playlist is represented by jacket cover art, users can readily see the next or previous song within the playlist, thus providing the user with an aesthetically-pleasing, visual overview of the nature of the playlist as the list is browsed.

According to this embodiment, a highlighted cursor or other selection indicator can be moved across the touchscreen and the thumbnails by the user, thus allowing the user to listen to the music (or other audio content) associated with the thumbnail that is selected. As the cursor scrolls between any two given thumbnails, the song/content associated with the first thumbnail crossfades into the song/content associated with the next thumbnail thereby permitting a smooth listening of each content selection that is being browsed. When the cursor is located between two thumbnails, both song tracks are played with their respective volume levels proportionally adjusted based on the proximity of the cursor to a general alignment with each thumbnail. Also, there is an analogous visual adjustment or “crossfading” of the relative display brightness levels associated with the two thumbnails as the cursor moves between them. Moreover, when the cursor is dragged to the edge of the matrix and held in that position for a predetermined amount of time (e.g., 2 seconds), the matrix goes into an automatic scroll mode to reveal additional content as additional playlists or as additional content associated with currently-displayed playlists.

According to this embodiment, no GUI is displayed initially; the screen is blank, or alternatively only a screen saver is shown. When the user touches the touchscreen, the GUI slowly appears or fades in. After another predetermined amount of time (e.g., 5-10 seconds) during which there has been no interaction by a user, the GUI slowly disappears, or fades out, again leaving a blank screen, or alternatively displaying a screensaver.

Some known media players, such as Microsoft Media Center™ or Apple Front Row™, display content in a thumbnail view. However they do not permit users to listen to music as they browse through playlists. The known media player provided under the name iTunes™ by Apple Computers Inc. allows users to listen to their playlists with audio crossfade between different song tracks, but this functionality is available only during content playback, and not during browsing. Also, certain known television and radio systems allow users to listen/view content as the channels are moved up and down. However these experiences are only limited to TV and radio programming. On the other hand, the inventors are aware of no previously-known system that allows users to browse content visually through thumbnails while listening to the content, or to crossfade audio content as they browse through a content list, or to visually see the playlists so that the next and previous songs can all be seen in thumbnail view.

Embodiments of the invention allow users to both browse and listen to large collections of content at the same time, simply by dragging the highlight cursor, or scrolling the entire thumbnail matrix left/right or up/down using slider controls. This helps users find a specific item of content through both visual and auditory cues.

Real-time crossfading provides a seamless transition from one item of content to another, eliminating abrupt content cut-off or switching. This makes the browsing experience more seamless, continuous and comfortable. This also provides users with a new way of experiencing their content collection, by combining browsing with the listening and viewing experiences. As a result, a simple browsing becomes a kind of content-mixing experience.

Embodiments of the invention allow users to visually see their content collections in an overview fashion. Because of the way the content thumbnails or other icons are displayed in a matrix fashion that includes long, multiple thumbnail lists, users can visually see an overview of their list, including the order of upcoming songs and previous songs. As a result, browsing itself becomes a new way of listening and experiencing content, almost as if the user is mixing his/her own content.

Referring now to FIG. 1, shown is a portable storage device 108 and an audio player 102 according to one embodiment of the invention. The audio player 102 is comprised of a base unit 104 and a display 106 horizontally mounted on the base unit 104. The portable storage device 108 is adapted for placement on a surface 110 of the display 106.

The audio player 102 is for playing a plurality of audio streams of data, such as for example, music, audio books, lectures, etc. The audio player 102 is essentially a special-purpose computer that executes a media player program for playing the media streams. The base unit 104 encloses circuitry for use in playing the audio streams. The display 106 is for presenting a graphical user interface (GUI) configured for operating the player 102. The display 106 is a touchscreen display that is responsive to a user input device, such as for example a digital pen, a pointer device or a user's finger (not shown).

The portable storage device 108 contains data for use in generating the plurality of audio streams, such as for example MP3 data files. The storage device 108 is external to the audio player 102 and includes one or more hard disk drives, flash memories or other memory or data storage devices. The portable storage device 108 automatically and wirelessly communicates with the audio player 102 when the storage device 108 is placed upon the horizontal surface 110 of the touchscreen display 106. Power for the storage device 108 is obtained from a replaceable battery or from a rechargeable battery that can obtain its power from the touchscreen 106 or the base unit 104 via inductive coupling. The storage device 108 includes a housing 112 that is in the shape of a stone with smooth surfaces thus providing an aesthetically-pleasing appearance. However other embodiments include housings having other shapes or geometries.

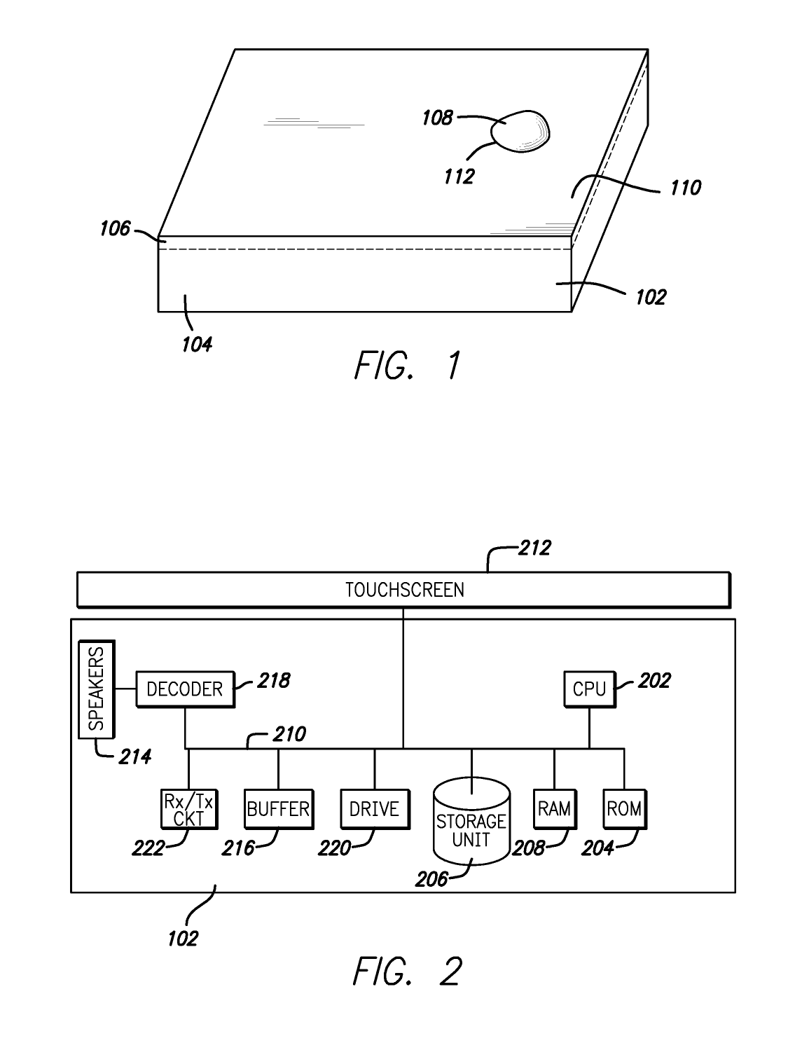

FIG. 2 illustrates an exemplary configuration of the audio player 102 of FIG. 1 according to an embodiment of the invention. Referring to FIG. 2, a central processing unit (CPU) 202 executes a variety of processing operations as directed by programs stored in a read only memory (ROM) 204 or loaded from a storage unit 206 into a random access memory (RAM) 208. The RAM 208 also stores data and so on necessary for the CPU 202 to execute a variety of processing operations as required.

The CPU 202, the ROM 204, and the RAM 208 are interconnected via a bus 210. The bus 210 further connects an input-output device 212 composed of a touchscreen interface, an output device composed of a set of speakers 214 for example, and the storage unit 206 based on a hard disk drive for example.

The ROM 204, RAM 208 and/or the storage unit 206 stores operating software used to enable operation of the audio player 102. The storage unit 206 transfers information with the CPU 202 to store and delete information. A buffer 216 receives and buffers sequential portions of streaming content when received via a network, such as the Internet (not shown) or via other streaming sources. The content is sent to a decoder 218 which decodes, and if necessary decrypts, the content prior to sending it to the one or more speakers 214.

The bus 210 is also connected with a drive 220 as required on which a magnetic disk, an optical disk, a magneto-optical disk, or a semiconductor memory for example is loaded for content data, computer programs or other data read from any of these recording media being installed into the storage unit 206 or for playing via the speakers 214. Wireless transceiver (Rx/Tx) circuitry 222 is also connected to the bus 210 and is used to communicate with a portable storage device, such as the portable storage device 108 of FIG. 1, as well as other wireless components as may be desired for communication with the audio player 102.

Although not shown, the portable storage device is also configured as a special purpose computer which has basically a similar configuration as that of the audio player 102 shown in FIG. 2, except that the portable storage device may not have certain components, such as a decoder, speakers, a buffer, a driver, a touchscreen, etc. As previously mentioned however, the portable storage device is adapted for wireless communications with the audio player 102.

While FIG. 2 shows one configuration of the audio player 102, alternative embodiments include a general purpose computer, a portable playback device, or any other type of a computer device. For example, other input-output device combinations (including user input devices) could include a keyboard and mouse for input, and a CRT monitor or a flat panel monitor for output. Alternative input/output devices may further include a proximity display screen, a holographic display or a projector display. A proximity display screen is similar to a touchscreen, but differs in that it accepts commands from a user's finger or pointer device that is disposed close to the screen surface but does not touch it. Holographic displays and projection displays provide a GUI in the air or on a surface of a wall or paper, as the case may be. They accept user commands from a pointer device or user's finger that is disposed in the same air space as is occupied by the projected GUI.

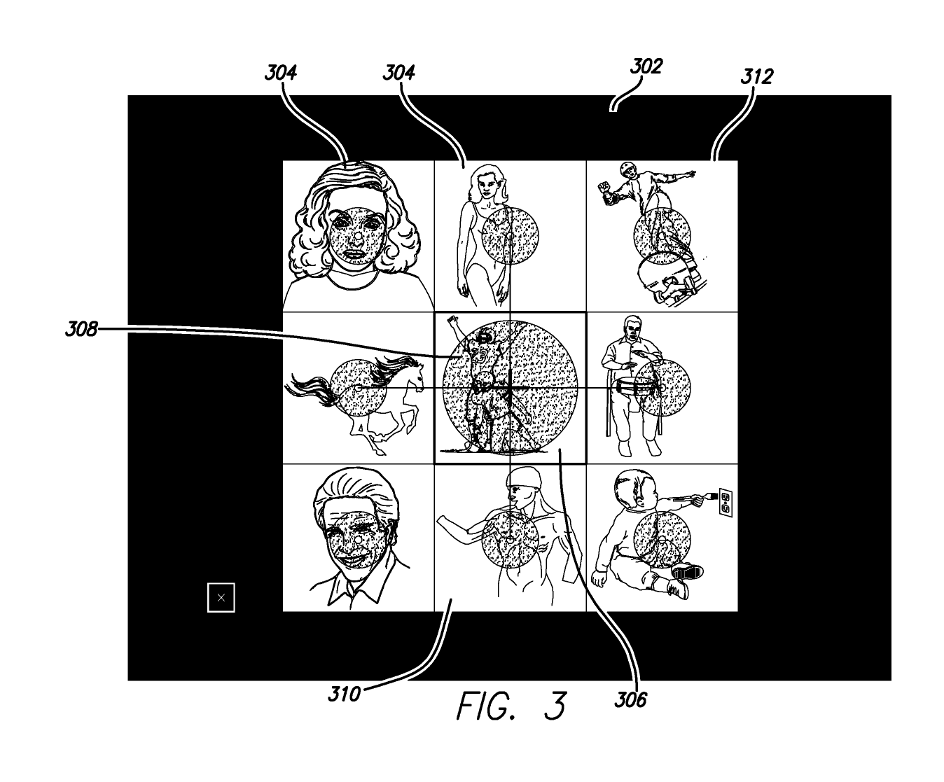

FIGS. 3-5 show a GUI 302 in accordance with an embodiment of the invention. The GUI 302 includes a plurality of thumbnails 304 displayed in a matrix 312 and associated with a plurality of audio streams (not shown). Also included is a selection indicator 308 that moves in response to a user input device, such as for example a pointer device, a digital pen or a user's finger (not shown). In other embodiments, the selection indicator 308 can be moved by any suitable means, such as by a stylus, keypad, mouse, voice activation device or any other suitable mechanism. The selection indicator 308 is in the shape of a circle with a plus sign or cross in the center. If the selection indicator 308 is generally aligned with a selected thumbnail 306 as shown in FIG. 3, then the audio stream that is associated with that thumbnail 306 is played by the audio player. Also, the selected thumbnail 306 is displayed at a first brightness that is greater than the brightness of the remaining thumbnails 304, thus highlighting the identity of the song or audio stream that is currently selected and playing.

Similarly, if the selection indicator 308 is generally aligned with a second selected thumbnail 310 as shown in FIG. 5, then another one of the audio streams that is associated with that second thumbnail 310 is played. As before, when selected the second thumbnail 310 is displayed at a brightness that is greater than the brightness of the remaining thumbnails.

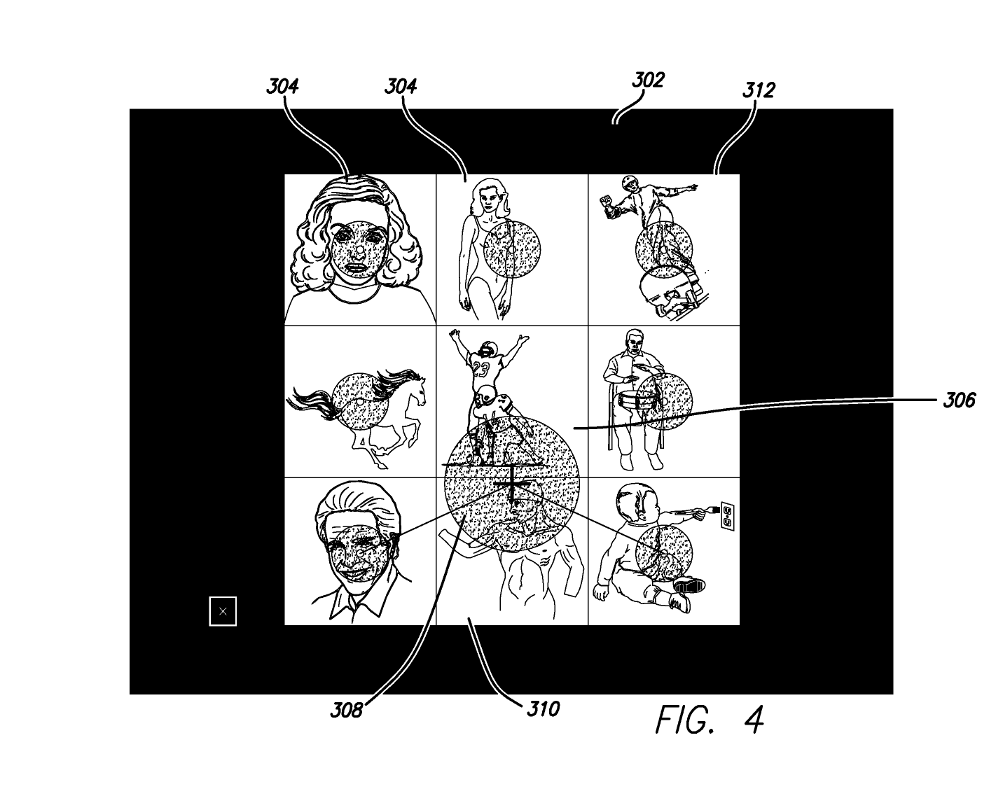

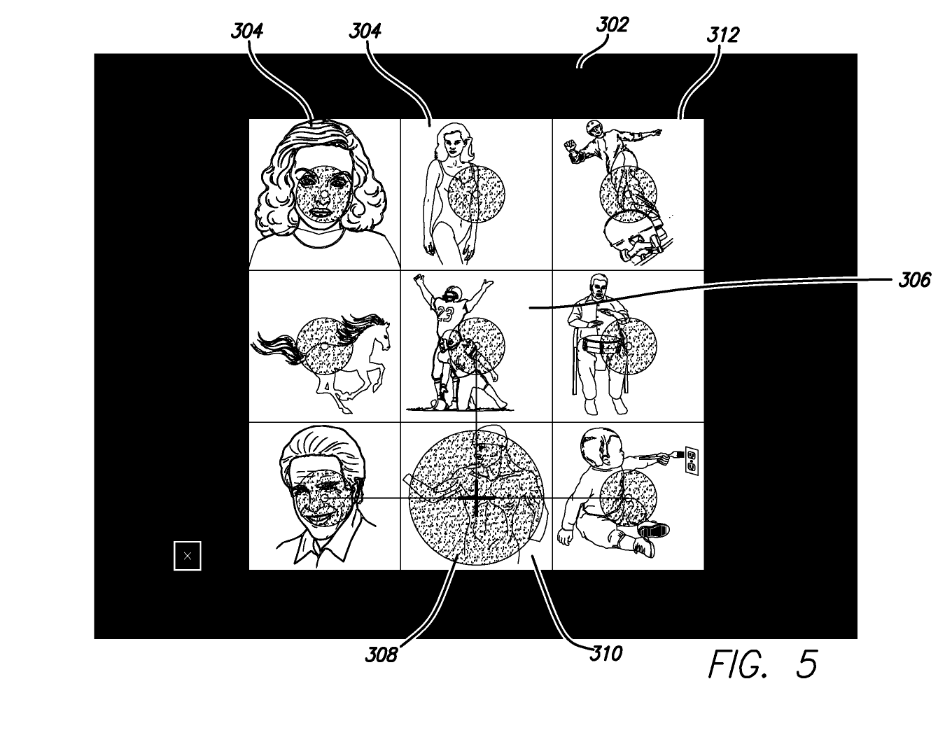

As the selection indicator 308 is moved by the user from the first selected thumbnail 306 to the second selected thumbnail 310 as shown in FIG. 4, the first audio stream associated with the first thumbnail 306 mixes with the second audio stream associated with the second thumbnail 310 so that the first audio stream crossfades into the second audio stream. That is, when the selection indicator 308 is aligned with the first thumbnail 306 as shown in FIG. 2, then only the first audio stream associated with that thumbnail is heard. As the selection indicator 308 moves toward the second thumbnail 310 thus overlapping both the first and second thumbnails 306, 310, both the first and second audio streams are mixed and thus are played simultaneously.

The first audio stream is played at a first decibel level and the second audio stream is played at a second decibel level while the audio streams are simultaneously playing. The first and second decibel levels each vary as the selection indicator 308 is moving, so that each decibel level is in proportion to the proximity of the selection indicator 308 to a position of general alignment with one of the two thumbnails 306, 310. Thus for example, when the selection indicator 308 first starts moving away from the first thumbnail 306, it is still closer to being aligned with that thumbnail as compared with an alignment with the second thumbnail 310. Therefore the first decibel level is greater than the second decibel level.

As the selection indicator 308 approaches the midpoint between the thumbnails, the first decibel level reduces and the second decibel level increases until the selection indicator 308 is equidistant between the thumbnails at which point the first and second decibel levels are equal. Then as the selection indicator 308 continues in a direction toward alignment with the second thumbnail 310, the second decibel level becomes greater than the first decibel level, and continues to increase as the selection indicator 308 moves until it is aligned with the second thumbnail 310 at which point only the second audio stream can be heard. Thus as the selection indicator 308 is moved between thumbnails, there is a smooth, continuous crossfading of one audio stream into another thereby providing an aesthetically pleasing listening experience for the user.

Moreover, there is an analogous visual adjustment or “crossfading” of the brightness levels associated with the two thumbnails as the selection indicator 308 moves from one to the other. As previously mentioned, when the selection indicator 308 is generally aligned with the first thumbnail 306 and only the first audio stream is playing, the first thumbnail 306 is displayed at a greater brightness level than the remaining thumbnails 304 in the matrix 312, including the second thumbnail 310. However, as the selection indicator 308 is moved from the first thumbnail 306 to the second thumbnail 310, the greater brightness associated with the first thumbnail 306 begins to fade and the lower brightness associated with the second thumbnail 310 begins to increase. This trend continues until the selection indicator 308 is generally aligned with the second thumbnail 310 at which point it is now displayed at the greater brightness level and the first thumbnail 306 is displayed at the lower brightness level along with the remaining thumbnails 304 in the matrix 312.

According to an embodiment of the invention, the touchscreen is blank when the audio player is playing an audio stream but when the GUI it is not in use for entering user commands. Alternatively rather than blank, the touchscreen can display a screen saver or other images that move according to a predefined, fixed motion pattern. Alternatively if music is being played, the images move synchronously with the music. However, the thumbnails slowly fade into view in response to placement of the user input device on the touchscreen and holding the input device there for a predetermined time period. After another predetermined time period has elapsed during which no user command is entered using the GUI, all thumbnails slowly fade out of view until the screen is blank (or displays a screensaver).

As previously mentioned, the selection indicator 308 shown in FIGS. 3-5 is in the shape of a circle with a plus sign or cross in the center. In other embodiments, the selection indicator can include any other shape or geometry, and can include a cursor that is driven by a computer mouse or keyboard. Also, while the GUI 302 of FIGS. 3-5 includes thumbnails arranged in a matrix, alternative embodiments include icons that are other than thumbnails and that may be arranged in a matrix or arranged in layouts other than matrices.

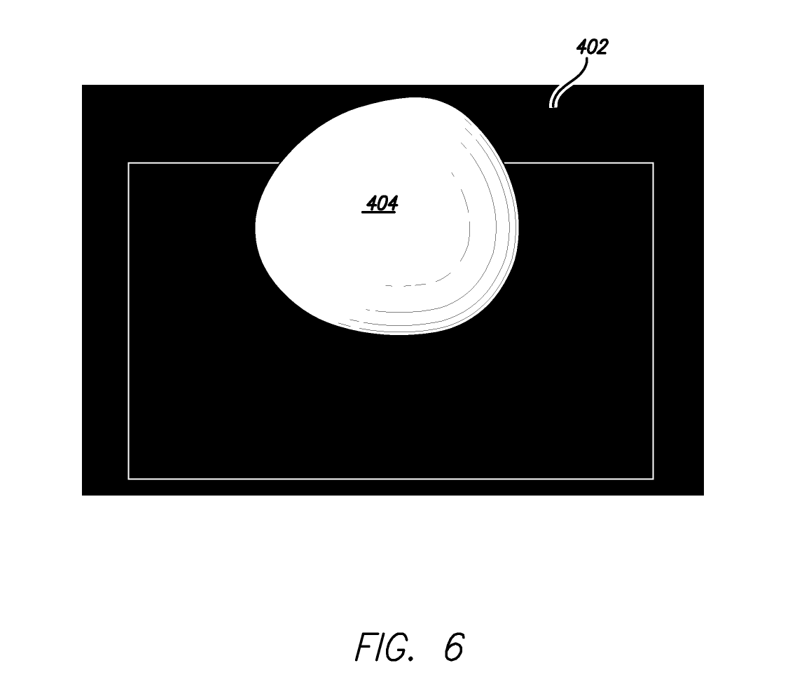

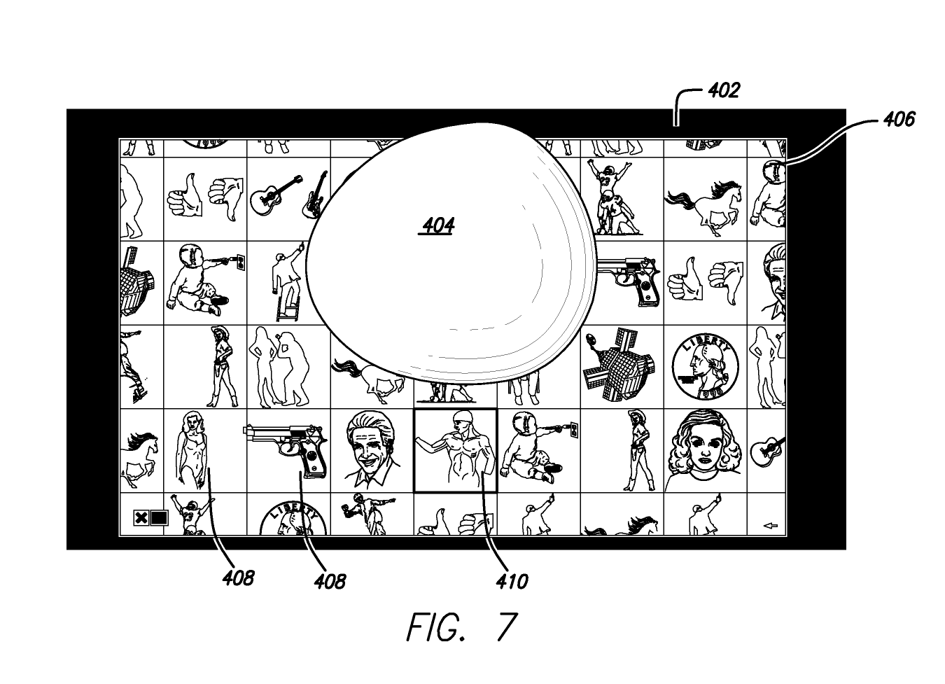

In another embodiment shown in FIGS. 6-7, a GUI fades into view in response to the use of a portable storage device, such as the portable storage device 108 of FIG. 1. First, a touchscreen 402 that is initially blank remains blank at the instant that a portable storage device 404 is placed upon it. (FIG. 6) The touchscreen 402 is blank at this point in time, because no user command has been entered for a predetermined period of time, or because the system has been powered on. However, within a matter of seconds after the portable storage device 404 is placed on the touchscreen 402, its presence is automatically detected by the system whereupon a GUI 406 (including a plurality of thumbnails 408) slowly fades into view. (FIG. 7) When an audio stream is playing or preselected for playing at the time that the portable storage device 404 is placed on the screen 402, then a corresponding thumbnail 410 is displayed at a brightness that is greater than that of the other thumbnails 408.

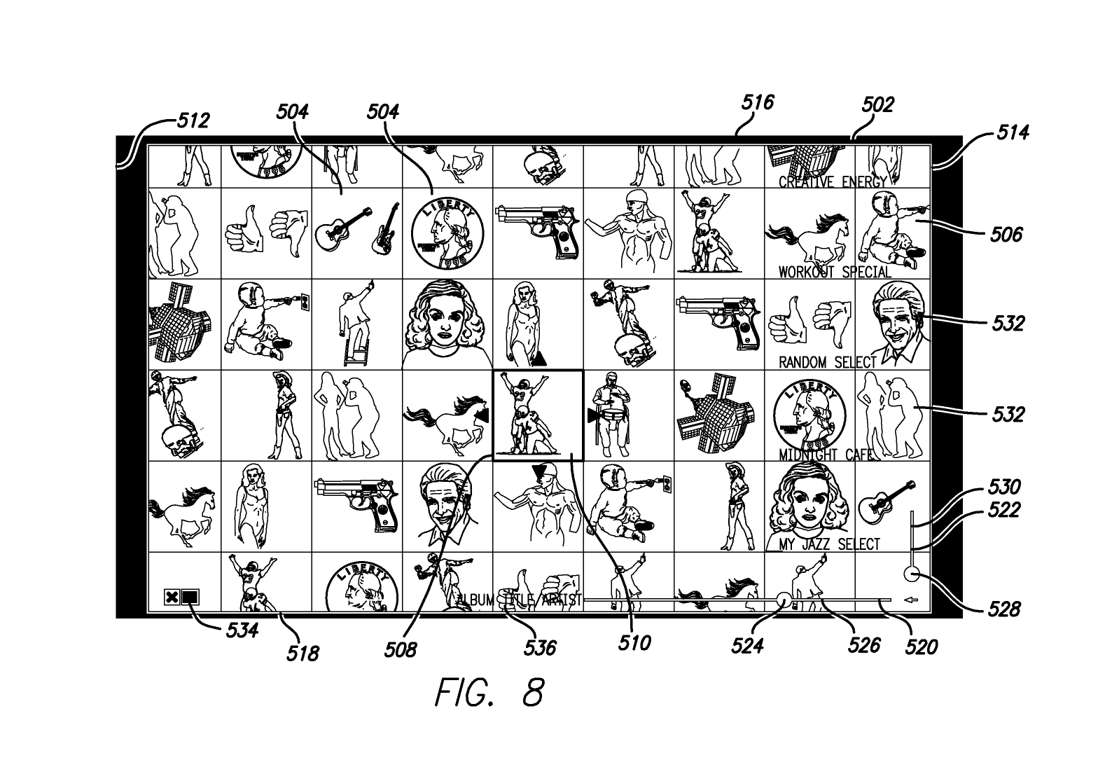

FIG. 8 shows a GUI 502 in accordance with yet another embodiment of the invention. As before, the GUI 502 is comprised of a plurality of thumbnails 504 arranged in a matrix 506 and associated with a plurality of audio streams. In this case the audio streams include content comprising music, and the thumbnails 504 are music jacket cover art. A selection indicator 508 is in the shape of a square having dimensions such that when it is in alignment with a selected thumbnail 510, the indicator 508 forms a highlighted border of the thumbnail 510. As before, an audio stream associated with the selected thumbnail 510 is played and the selected thumbnail 510 is displayed at a greater brightness than the remaining thumbnails 504 in the matrix 506. Also, as the selection indicator 508 is moved from one thumbnail to another, the first audio stream crossfades into another audio stream.

If the system has more thumbnails than can be simultaneously displayed on one screen, the matrix 506 can be made to scroll in any direction to reveal additional thumbnails for selection. For example, when the selection indicator 508 is moved to the left edge 512 of the matrix 506 and held in that position for a predetermined time, such as for example 3 seconds, then the entire matrix 506 will scroll horizontally from left to right across the touchscreen. Similarly, holding the selection indicator 508 at the right edge 514 of the matrix 506 will cause the matrix 506 to scroll horizontally from right to left, holding the selection indicator 508 at the top edge 516 will cause the matrix 506 to scroll vertically from the top to the bottom of the screen, and holding the selection indicator 508 at the bottom edge 518 will cause the matrix 506 to scroll from the bottom to the top of the screen.

Also shown in FIG. 8 are a horizontal slider icon 520 and a vertical slider icon 522, each of which provides an alternative way to scroll the matrix 506. The horizontal slider icon 520 includes a circle or dot 524 superimposed upon a horizontal line 526. Similarly, the vertical slider icon 522 includes a circle or dot 528 superimposed upon a vertical line 530. When a user touches the circle or dot 524 of the horizontal slider icon 520 with a user input device and slides the dot 524 to the right or left along the horizontal line 526, the matrix 506 of thumbnails scrolls to the right or the left, as the case may be, in response to this horizontal movement of the dot 524. Similarly, when the user touches the circle or dot 528 of the vertical slider icon 522 and slides the dot 528 up or down along the vertical line 530, the matrix 506 of thumbnails scrolls up or down, as the case may be, in response to this vertical movement of the dot 528. Although the slider icons in FIG. 8 are circles or dots superimposed upon a horizontal or vertical line, it will be appreciated by those skilled in the art that other shapes and geometries of icons can be used as well for scrolling the matrix 506 in any direction.

The audio streams corresponding to the thumbnails 504, 510 shown in FIG. 8 are organized into a plurality of content categories. The thumbnails 504 in the matrix 506 are displayed in a plurality of horizontal rows 532, and each row 532 represents a playlist of audio streams associated with a content category, such as for example genre, artist, album and user favorite, etc. In FIG. 8, the playlist content categories are labeled “Creative Energy,” “Workout Special,” “Random Select,” “Midnight Café,” and “My Jazz Select.” These are examples only, however, and any category name can be defined and used for organizing the audio streams and thumbnails. While the embodiment of FIG. 8 shows an organization whereby each row is a playlist and content category, it could alternatively be organized such that each vertical column is a playlist and content category.

The GUI 502 of FIG. 8 further includes a display of metadata 536 associated with audio streams. The metadata includes the names of the content categories for each playlist as previously discussed above. The metadata further includes a title of a song currently being played, an identity of an artist of the song currently being played, and a track counter of the song currently being played. In other embodiments of the invention, other metadata may be displayed as well. The GUI 502 includes a metadata display icon 534 that toggles between three modes: “on” and “off” and “screensaver.” If the metadata is being displayed along with the matrix 506 of thumbnails (i.e., the “on” mode), the metadata can be made to disappear by touching the metadata display icon 534 with a user input device (not shown), although the matrix 506 will remain displayed. If the metadata is not displayed but the matrix 506 is displayed (i.e., the “off” mode), the matrix 506 will disappear and a screensaver (or a blank screen) will appear in response to touching the metadata display icon 534 a second time. If the screensaver (or a blank screen) is displayed (i.e., the “screensaver” mode), the metadata and the matrix 506 will appear in response to touching the metadata display icon 534 a third time.

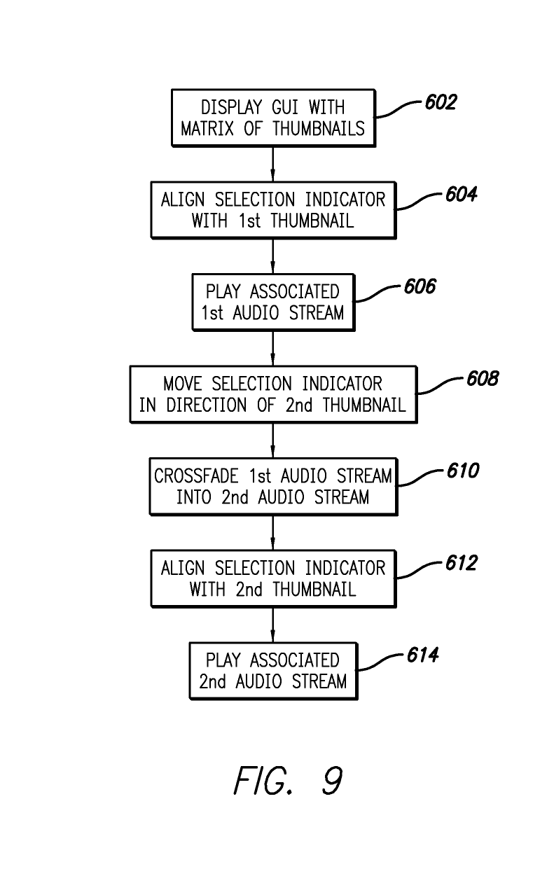

FIG. 9 is a flow diagram showing a method of playing audio streams according to one embodiment of the invention. First, a GUI having a plurality of thumbnails associated with a plurality of audio streams is displayed. (Step 602) Using a user input device, such as a digital pen or a finger of a user, a selection indicator portion of the GUI is moved so that the indicator is generally aligned with a first thumbnail. (Step 604) In response, a first audio stream that is associated with the first thumbnail is played while other audio streams do not play. (Step 606) Then using the user input device, the selection indicator is moved away from the first thumbnail in a direction toward a second thumbnail. (Step 608) In response, the first audio stream crossfades into a second audio stream that is associated with the second thumbnail. (Step 610) Still using the user input device, the selection indicator is moved so that it is generally aligned with the second thumbnail. (Step 612) In response, the second audio stream is played while the first audio stream no longer is being played. (Step 614)

Thus disclosed, according to an embodiment of the invention, is an improved graphical user interface (GUI) for use with an audio player (or other device) having a touchscreen or similar display. The content that is available for playing is represented by a plurality of thumbnails, such as for example jacket cover art, displayed in a matrix. The matrix includes multiple playlists stacked vertically. A highlighted cursor or other selection indicator can be moved across the touchscreen and the thumbnails by a user, thus allowing the user to listen to the music or other content associated with the selected thumbnail. As the selection indicator moves between any two given thumbnails, the song or other content associated with the first thumbnail crossfades into the song/content associated with the next thumbnail thereby permitting a smooth listening experience for each content selection that is being browsed.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A graphical user interface (GUI) for use with a user input device and for playing a first audio stream and a second audio stream, the GUI comprising:
a first icon displayed proximate to a second icon, wherein the first icon is associated with the first audio stream and the second icon is associated with the second audio stream; and
a selection indicator adapted to move in response to the user input device,
wherein the first audio stream is played if the selection indicator is generally aligned with the first icon,
wherein the second audio stream is played if the selection indicator is generally aligned with the second icon, and
wherein the first audio stream crossfades into the second audio stream in response to a movement of the selection indicator from the first icon to the second icon.

2. The GUI of claim 1 wherein the first icon is displayed at a first brightness and the second icon is displayed at a second brightness that is less than the first brightness when the first audio stream is playing and the second audio stream is not playing, and wherein the second icon is displayed at the first brightness and the first icon is displayed at the second brightness when the second audio stream is playing and the first audio stream is not playing.

3. The GUI of claim 1 wherein the first audio stream is played at a first decibel level and the second audio stream is played at a second decibel level when the first audio stream crossfades into the second audio stream, and wherein the first and second decibel levels are in proportion to the proximity of the selection indicator to a position of general alignment with one of the first icon and the second icon.

4. The GUI of claim 1 wherein the GUI is for display on a touchscreen responsive to the user input device, wherein the first and second icons are not displayed after a predetermined time period has elapsed during which there have been no user commands entered using the GUI, and wherein the first and second icons fade into view in response to placement of the user input device on the touchscreen.

5. A graphical user interface (GUI) for use with a user input device and for playing a plurality of audio streams, the GUI comprising:
a plurality of content icons displayed in a matrix and associated with the plurality of audio streams; and
a selection indicator adapted to move in response to the user input device,
wherein a first one of the plurality of audio streams is played if the selection indicator is generally aligned with a first one of the plurality of content icons,
wherein a second one of the plurality of audio streams is played if the selection indicator is generally aligned with a second one of the plurality of content icons, and
wherein the first one of the plurality of audio streams crossfades into the second one of the plurality of audio streams in response to a movement of the selection indicator from the first one of the plurality of content icons to the second one of the plurality of content icons.

6. The GUI of claim 5 wherein the first one of the plurality of content icons is displayed at a first brightness and the remaining of the plurality of content icons is displayed at a second brightness that is less than the first brightness when the first one of the plurality of audio streams is playing and the second one of the plurality of audio streams is not playing, and wherein the second one of the plurality of content icons is displayed at the first brightness and the remaining of the plurality of content icons is displayed at the second brightness when the second one of the plurality of audio streams is playing and the first one of the plurality of audio streams is not playing.

7. The GUI of claim 5 wherein the first one of the plurality of audio streams is played at a first decibel level and the second one of the plurality of audio streams is played at a second decibel level when the first one of the plurality of audio streams crossfades into the second one of the plurality of audio streams, and wherein the first and second decibel levels are in proportion to the proximity of the selection indicator to a position of general alignment with one of the first one of the plurality of content icons and the second one of the plurality of content icons.

8. The GUI of claim 5 wherein the GUI is for display on a touchscreen responsive to the user input device, wherein the plurality of content icons is not displayed after a first predetermined time period has elapsed during which no user command was entered using the GUI, and wherein the plurality of content icons fades into view in response to placement of the user input device on the touchscreen.

9. The GUI of claim 5 wherein the GUI is for display on a touchscreen responsive to the user input device and horizontally mounted on a base unit that encloses circuitry for use in playing the plurality of audio streams, wherein the GUI is further for use with a portable storage device that contains data for use in generating the plurality of audio streams, wherein the plurality of content icons is not displayed after a first predetermined time period has elapsed during which no user command was entered using the GUI, and wherein the plurality of content icons fades into view in response to placement of the portable storage device on the touchscreen.

10. The GUI of claim 5 wherein the matrix of the plurality of content icons is adapted to scroll from left to right thereby displaying a second plurality of content icons associated with a second plurality of audio streams, and wherein the matrix of the plurality of content icons is adapted to scroll from right to left thereby displaying a third plurality of content icons associated with a third plurality of audio streams.

11. The GUI of claim 10 wherein the matrix has a left edge and a right edge, wherein the matrix of the plurality of content icons is adapted to scroll from left to right in response to a movement of the selection indicator to the left edge, and wherein the matrix of the plurality of content icons is adapted to scroll from right to left in response to the movement of the selection indicator to the right edge.

12. The GUI of claim 10 wherein the GUI further comprises a slider icon adapted to move in response to the user input device, wherein the matrix of the plurality of content icons is adapted to scroll from left to right in response to a movement of the slider icon in a first direction, and wherein the matrix of the plurality of content icons is adapted to scroll from right to left in response to a movement of the slider icon in a second direction that is opposite from the first direction.

13. The GUI of claim 5 wherein the matrix of the plurality of content icons is adapted to scroll from top to bottom thereby displaying a second plurality of content icons associated with a second plurality of audio streams, and wherein the matrix of the plurality of content icons is adapted to scroll from bottom to top thereby displaying a third plurality of content icons associated with a third plurality of audio streams.

14. The GUI of claim 13 wherein the matrix has a top edge and a bottom edge, wherein the matrix of the plurality of content icons is adapted to scroll from top to bottom in response to a movement of the selection indicator to the top edge, and wherein the matrix of the plurality of content icons is adapted to scroll from bottom to top in response to the movement of the selection indicator to the bottom edge.

15. The GUI of claim 13 wherein the GUI further comprises a slider icon adapted to move in response to the user input device, wherein the matrix of the plurality of content icons is adapted to scroll from top to bottom in response to a movement of the slider icon in a first direction, and wherein the matrix of the plurality of content icons is adapted to scroll from bottom to top in response to a movement of the slider icon in a second direction that is opposite from the first direction.

16. The GUI of claim 5 wherein the plurality of audio streams is adapted for organization into a plurality of content categories, wherein the plurality of content icons displayed in the matrix is displayed in a plurality of horizontal rows, wherein the plurality of horizontal rows of content icons is associated with the plurality of content categories of audio streams.

17. The GUI of claim 16 wherein one of the plurality of content categories is one of a genre, an artist, an album and a user favorite.

18. The GUI of claim 5 wherein the plurality of audio streams is adapted for organization into a plurality of content categories, wherein the plurality of content icons displayed in the matrix is displayed in a plurality of vertical columns, and wherein the plurality of vertical columns of content icons is associated with the plurality of content categories of audio streams.

19. The GUI of claim 5 wherein the plurality of audio streams includes content comprising music, the GUI further comprising a display of metadata associated with at least one of the plurality of audio streams.

20. The GUI of claim 19 wherein the metadata comprises one of a plurality of music titles, a title of a song currently being played, an identity of an artist of the song currently being played, and a track counter of the song currently being played.

21. The GUI of claim 5 wherein the plurality of content icons is a plurality of thumbnails.

22. The GUI of claim 5 wherein the user input device is one of a digital pen, a pointer device and a finger of a user.

23. A method of playing a plurality of audio streams, the method comprising:
displaying a graphical user interface (GUI) having a selection indicator adapted to move in response to a user input device and having a plurality of icons displayed in a matrix and associated with the plurality of audio streams;
playing a first one of the plurality of audio streams when the selection indicator is generally aligned with a first one of the plurality of icons;
crossfading the first one of the plurality of audio streams into a second one of the plurality of audio streams when the selection indicator is moving in a direction from the first one of the plurality of icons to a second one of the plurality of icons; and
playing the second one of the plurality of audio streams when the selection indicator is generally aligned with the second one of the plurality of icons.

24. The method of claim 23 further comprising:
displaying the first one of the plurality of icons at a first brightness and the remaining of the plurality of icons at a second brightness that is less than the first brightness when the first one of the plurality of audio streams is playing and the second one of the plurality of audio streams is not playing; and
displaying the second one of the plurality of icons at the first brightness and the remaining of the plurality of icons at the second brightness when the second one of the plurality of audio streams is playing and the first one of the plurality of audio streams is not playing.

25. The method of claim 23 wherein crossfading the first one of the plurality of audio streams into the second one of the audio streams includes:
playing the first one of the plurality of audio streams at a first decibel level; and
playing the second one of the plurality of audio streams at a second decibel level,
wherein the first and second decibel levels are in proportion to the proximity of the selection indicator to a position of general alignment with one of the first one of the plurality of icons and the second one of the plurality of icons.

26. The method of claim 23 wherein displaying the GUI includes displaying the GUI on a touchscreen responsive to the user input device, the method further comprising:
fading the plurality of icons out of view after a first predetermined time period has elapsed during which no user command was entered using the GUI; and
fading the plurality of icons into view in response to a placement of the user input device on the touchscreen.

27. The method of claim 23 wherein displaying the GUI includes displaying the GUI on a touchscreen responsive to the user input device and horizontally mounted on a base unit that encloses circuitry for use in playing the plurality of audio streams, the method further comprising:
fading the plurality of icons out of view after a first predetermined time period has elapsed during which no user command was entered using the GUI; and
fading the plurality of icons into view in response to a placement of a portable storage device on the touchscreen, wherein the portable storage device contains data for use in generating the plurality of audio streams.

28. A system for playing a plurality of audio streams and for use with a user input device, the system comprising:
a media player program for playing the plurality of audio streams; and
a computer adapted to execute the media player program, wherein the computer has a display for presenting a graphical user interface (GUI) configured for operation on the computer,
wherein the GUI includes:
a plurality of icons displayed in a matrix and associated with the plurality of audio streams; and
a selection indicator adapted to move in response to the user input device,
wherein a first one of the plurality of audio streams is played if the selection indicator is generally aligned with a first one of the plurality of icons,
wherein a second one of the plurality of audio streams is played if the selection indicator is generally aligned with a second one of the plurality of icons, and
wherein the first one of the plurality of audio streams crossfades into the second one of the plurality of audio streams in response to a movement of the selection indicator from the first one of the plurality of icons to the second one of the plurality of icons.

29. The system of claim 28 wherein the first one of the plurality of icons is displayed at a first brightness and the remaining of the plurality of icons is displayed at a second brightness that is less than the first brightness when the first one of the plurality of audio streams is playing and the second one of the plurality of audio streams is not playing, and wherein the second one of the plurality of icons is displayed at the first brightness and the remaining of the plurality of icons is displayed at the second brightness when the second one of the plurality of audio streams is playing and the first one of the plurality of audio streams is not playing.

30. The system of claim 28 wherein the first one of the plurality of audio streams is played at a first decibel level and the second one of the plurality of audio streams is played at a second decibel level when the first one of the plurality of audio streams crossfades into the second one of the plurality of audio streams, and wherein the first and second decibel levels are in proportion to the proximity of the selection indicator to a position of general alignment with one of the first one of the plurality of icons and the second one of the plurality of icons.

31. The system of claim 28 wherein the display is a touchscreen responsive to the user input device, wherein the plurality of icons is not displayed after a first predetermined time period has elapsed during which no user command was entered using the GUI, and wherein the plurality of icons fades into view in response to a placement of the user input device on the touchscreen.

32. The system of claim 28 wherein the computer further includes:
a base unit that encloses circuitry for use in playing the plurality of audio streams; and
a portable storage device that contains data for use in generating the plurality of audio streams,
wherein the display is a touchscreen responsive to the user input device and horizontally mounted on the base unit,
wherein the plurality of icons is not displayed after a first predetermined time period has elapsed during which no user command was entered using the GUI, and
wherein the plurality of icons fades into view in response to the placement of the portable storage device on the touchscreen.
